(19) United States
(12) Patent Application Publication
(10) Pub. No.: US 2006/0167994 A1
(43) Pub. Date: Jul. 27, 2006

(54) System and method for automatically segmenting content from an instant messaging transcript and applying commands contained within the content segments

(76) Inventors: Yen-Fu Chen, Austin, TX (US); John Hans Handy-Bosma, Cedar Park, TX (US); Mei Yang Selvage, Austin, TX (US); Keith Raymond Walker, Austin, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/032,884

(22) Filed: Jan. 11, 2005

(51) Int. Cl. G06F 15/16

(52) U.S. Cl. 709/204

(57) ABSTRACT

A system and method for automatically segmenting content from an instant messaging transcript and applying commands contained within the content segments is disclosed. The system includes a segment finding program, a command finding program, and a command list. The segment finding program identifies topic shifts in the IM conversation. The command finding program searches the identified topic segments for commands. Upon finding a command, the command finding program locates an appropriate action within the command list and executes it after obtaining user permission if so specified. The system works in conjunction with an IM program having functions to allow each user to control the segment finding and command finding programs.

### CROSS-REFERENCE TO RELATED APPLICATION

The present invention is related to the subject matter of U.S. patent application Ser. No. 10/824,811, “System for Turn and Topic Based Repositories,” incorporated herein by reference.

### FIELD OF THE INVENTION

The present invention relates generally to Instant Messaging, and specifically to finding and acting upon commands contained within segments of “chats” using either a client computer, a server computer or both the client computer and the server computer.

### BACKGROUND OF THE INVENTION

Instant Messaging (IM) is a communication service that allows a user on one computer to send and receive text messages in real time with another user on a second computer connected to the first computer by the Internet or other distributed communications protocol. In one version of instant messaging, the channel for this communication is often referred to metaphorically as a chat room, and the communication over the channel is referred to as chat. In another version, two or more users engage in an instant messaging conversation outside the boundaries of a chat room. Each user is able to view a chat transcript on one or more local machines. Each user has a list of other users with whom they may want to chat. The IM service may alert the user when another user, who is on the user's participant list, is online. A chat may then be started, and once started, either user can enter text that will appear on other user's displays.

Most network and online service providers offer IM. In the workplace, IM conversations often take place between people working on common projects. In engineering and computer design activities, it is not uncommon for one user to have ten or more multiple chats running simultaneously. Chats may describe simple information shared by two workers scheduling a meeting, or chats may contain complex discussions regarding proprietary information and critical decisions to keep a project moving forward. Frequently, chat participants interact with other programs besides IM, such as calendar programs, email programs, spreadsheets, and word processing programs, during the chat to obtain and/or record information. Therefore, it is useful to the participants for a computer program to monitor the chat, identify actions that it can take on the participants' behalf, and automatically perform those actions during or after the chat.

U.S. patent application Ser. No. 10/824,811 (the '811 application) disclosed a system and method for storing Instant Messaging text in a repository where it can be searched by topic or participant-based filters. The claimed program assigned topic tags to turns and topic shifts in the IM conversation. The preferred embodiment disclosed user selection of the tags, and an alternative embodiment disclosed allowing the user to elect “automatic topic tagging.” While the automatic topic tagging of the '811 docket application facilitated searching chat transcripts for information about particular topics, a number of needs were not met. The '811 docket made no provision for automatically introducing data from chats into other applications where needed. In addition, the '811 docket did not identify information needed by one or more participants during a chat, obtain the needed information from another application, and display the information to one or more of the participants.

Therefore, a need arises for a system and method for automatically segmenting content from an instant messaging transcript, and recognizing and applying commands contained within the content segments on either or both of the client computer and the server computer. A need further arises for users to be able to obtain information from other applications without leaving the IM application. A need also exists for information to be automatically provided to users as they need it without requesting it. Moreover, a need arises to provide information arising from chats to other applications automatically. Finally, a need exists for users to be able to control and see the results of actions arising from commands contained within chat content segments.

### SUMMARY OF THE INVENTION

The present invention, which meets the needs stated above, is a system and method for automatically segmenting content from an instant messaging transcript, and recognizing and applying commands contained within the content segments. In one embodiment, the system comprises three instant messaging programs running on three computers that are connected by a network, along with a segment finding program, a command finding program, and a command list loaded into the third computer's memory. The system may comprise additional embodiments, using a single computer, or various elements connected in any number of functional combinations that allow the segment finding program and the command finding program to function with one or more instant messaging programs. The segment finding program identifies topic shifts in the instant messaging conversation. The command finding program searches a topic segment for commands based on user determined criteria contained in the command list and executes an associated action upon locating a command. The command finding program may also perform the following: (1) report to a user that an action has been performed by logging it in a command log, (2) obtain permission from the user before executing an action, (3) report the result of an action to the user, and (4) identify a found command to a user. The segment finding program may also identify a found segment to the user. In addition, the segment finding and command finding programs may run retrospectively after completion of an instant messaging transcript.

The actions taken by the command finding program upon locating a command include (1) sending at least a portion of the segment to a pre-designated addressee, (2) sending at least a portion of the segment to a computer program, (3) sending an XML message containing at least a portion of the segment to a computer program, or (4) prompting a user to approve performance of an additional action. The user may specify (1) that at least a portion of the instant messaging transcript be sent only to the computer and not to any other participants in the instant messaging session, (2) that the result from an action be displayed only to the user and not to any other participants in the instant messaging session, or (3) that the result from an action be displayed to all participants in the instant messaging session. The invention may take the form of computer instructions for a computer on a computer-usable medium.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of a server computer associated with the present invention;

FIG. 3 is an illustration of the logic of the segment finding program associated with the present invention

FIG. 4 is an illustration of the logic of the command finding program associated with the present invention;

FIG. 5 is an illustration of a chat transcript;

FIG. 6 is an illustration of the logic of an action performed by the command finding program associated with the present invention

FIG. 7 is an illustration of an instant message display associated with the present invention;

FIG. 8 is an illustration of a pending commands display associated with the present invention;

FIG. 9 is an illustration of a command log display associated with the present invention; and

FIG. 10 is an illustration of the command list associated with the present invention.

### DETAILED DESCRIPTION OF THE PREFERRED EMBODIMENT

As used herein, the term “action” means the result of one or more instructions given to a computer in response to recognition and application of a command by a command finding program.

As used herein, the term “chat” means communication by one person at a computer with another person at a remote computer using instant messaging (IM).

As used herein, the term “chat transcript” means the text of the data transmitted by a first participant and the text of the data transmitted by a second participant during a chat.

As used herein, the term “command” means one or more words contained within a chat session that can be recognized by a command finding program so that a computer will be instructed to perform an action corresponding to the command.

As used herein, the term “computer” shall mean a machine having a processor, a memory, and an operating system, capable of interaction with a user or other computer, and shall include without limitation desktop computers, notebook computers, tablet computers, personal digital assistants (PDAs), servers, handheld computers, and similar devices.

As used herein, the term “instant messaging” (IM) means a communication service that allows a user on one computer to send and receive text messages in real time with another user on a second computer connected to the first computer by the Internet.

As used herein, the term “participant” means anyone connected to a chat while it is occurring.

As used herein, the term “topic” means a term or terms used to identify the subject of a chat transcript or of a chat transcript segment.

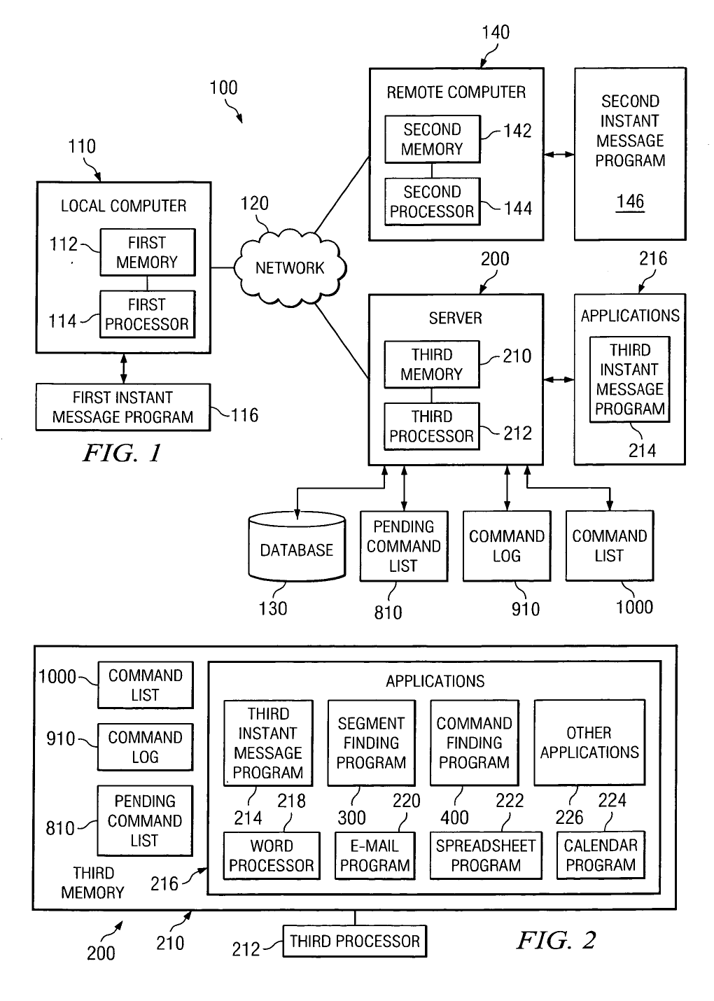

FIG. 1 is an illustration of computer network 100 associated with the present invention. Computer network 100 comprises local computer 110 electrically coupled to network 120. Local computer 110 is electrically coupled to remote computer 140 and server 200 via network 120. Network 120 may be a simplified network connection such as a local area network (LAN) or may be a larger network such as a wide area network (WAN) or the Internet or World Wide Web. Local computer 110 has first memory 112 and first processor 114 that run first instant messaging program 116. Remote computer 140 has second memory 142 and second processor 144 that run second instant messaging program 146. Server 200 has third memory 210 and third processor 212 that run third instant messaging program 214 and other applications 216. Server 200 is linked to database 130 and stores command list 1000, pending command list 810, and command log 910.

First memory 112, second memory 142, and third memory 210 may reside in server 200, database 130, or may be distributed in network 120 among one or more of server 200, local computer 110, or remote computer 140. Alternatively, first memory 112 may be combined with second memory 142 and third memory 210. First memory 112 is connected to network 120 by first processor 114. Second memory 142 is connected to network 120 by second processor 144. Third memory 210 is connected to network 120 by third processor 212.

The internal configuration of a computer, including connection and orientation of the processor, memory, and input/output devices, is well known in the art. The present invention is a methodology that can be embodied in a computer program. Referring to FIG. 2, server 200 stores command list 1000, command log 910, pending command list 810, and applications 216 in third memory 210 where they are operable by third processor 212. Applications 216 consist of third instant messaging program 214, word processor 218, email program 220, spreadsheet program 222, calendar program 224, segment finding program 300, command finding program 400, and other applications 226.

Computer network 100 depicted in FIG. 1 is intended as a representation of one possible operating network containing the present invention and is not meant as an architectural limitation. Persons skilled in the art will appreciate that the system and method for automatically segmenting content from an instant messaging transcript, and recognizing and applying commands contained within the content segments, may be configured in any combination of computers, processors, memories, storage devices, and networks in which a chat session is taking place across one or more networks. Likewise, the word processor 218, email program 220, spreadsheet program 222, and calendar program 224 depicted in FIG. 2 are intended as a representation of possible applications the present invention can interact with and are not meant as a limitation. For example, email program 220 may be Lotus notes email program, or it may be any other email program application with which a user may desire to interact with an instant messaging program using the system and method of the present invention.

FIG. 3 shows the logic of segment finding program 300. Segment finding program 300 begins (302) and receives input from instant messaging transcript 500 from third instant messaging program 214 (304). Segment finding program 300 then scans the input for a topic segment (306). If one is not found, segment finding program 300 terminates (314). Otherwise, the segment is identified to the user (310) as is illustrated in FIG. 7, and the command finding program 400 is executed (312) before segment finding program 300 terminates (314). A variety of techniques familiar to persons skilled in the art would be used to identify topic segments.

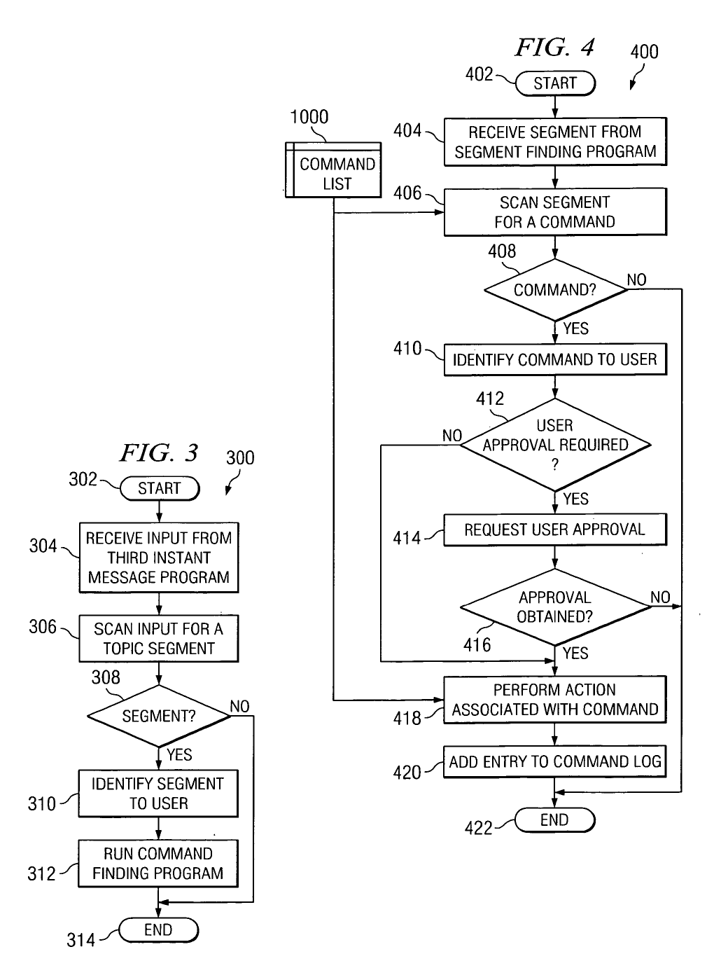

FIG. 4 shows the logic of command finding program 400. Command finding program 400 begins (402) and receives the topic segment located by the segment finding program 300 (404). Command finding program 400 then scans the input for a command using command list 1000 (406). If one is not found, command finding program 400 terminates (422). Otherwise, the command is identified to the user (410) as is illustrated in FIG. 7. If user approval is required to execute the action associated with the identified command (412), the command finding program 400 requests user approval (414) by making an entry to the pending command list 810 (414). Alternatively, the command finding program 400 could prompt the user for an immediate response. If the user does not grant approval (416), then command finding program 400 terminates (422). If user approval is not required, or once approval is obtained, then command finding program 400 performs an action associated with the command (418) obtained from command list 1000. After performing the action, command finding program 400 adds an entry to command log 910 (420) and then terminates (422). A variety of techniques familiar to persons skilled in the art would be used to identify commands, such as natural language processing.

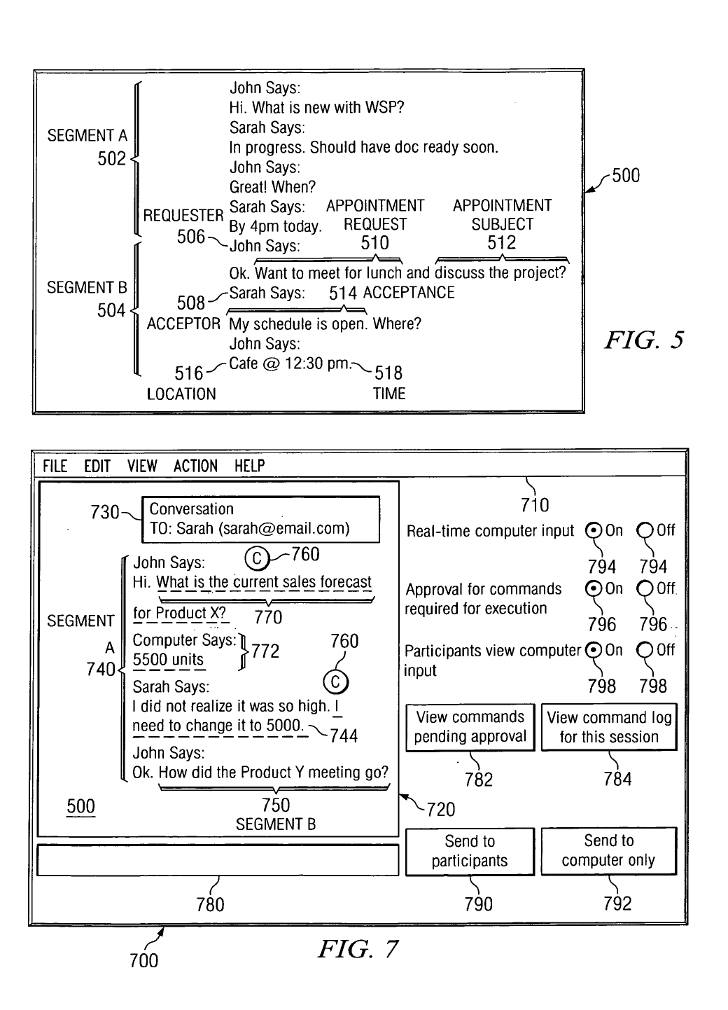

FIG. 5 depicts chat transcript 500. Chat transcript 500 consists of text that is processed by segment finding program 300 and command finding program 400 to identify actions that server 200 can take to aid participants in the chat. In this example, segment finding program 300 has segmented chat transcript 500 into segment A 502 and segment B 504. As each segment is identified, command finding program 400 scans each segment for commands. In segment B 504, command finding program 400 has identified appointment request 510 and acceptance 514 that comprise a command to schedule an appointment. Command finding program 400 then proceeds to identify requester 506, accepter 508, location 516, and time 518. In the absence of a date, command finding program 400 assumes the date of the appointment is the same as the date of the chat. Alternatively, command finding program 400 could ask the participants to provide the date of the appointment. Similarly, command finding program 400 could ask the participants for any other missing information needed to perform the action associated with the identified command.

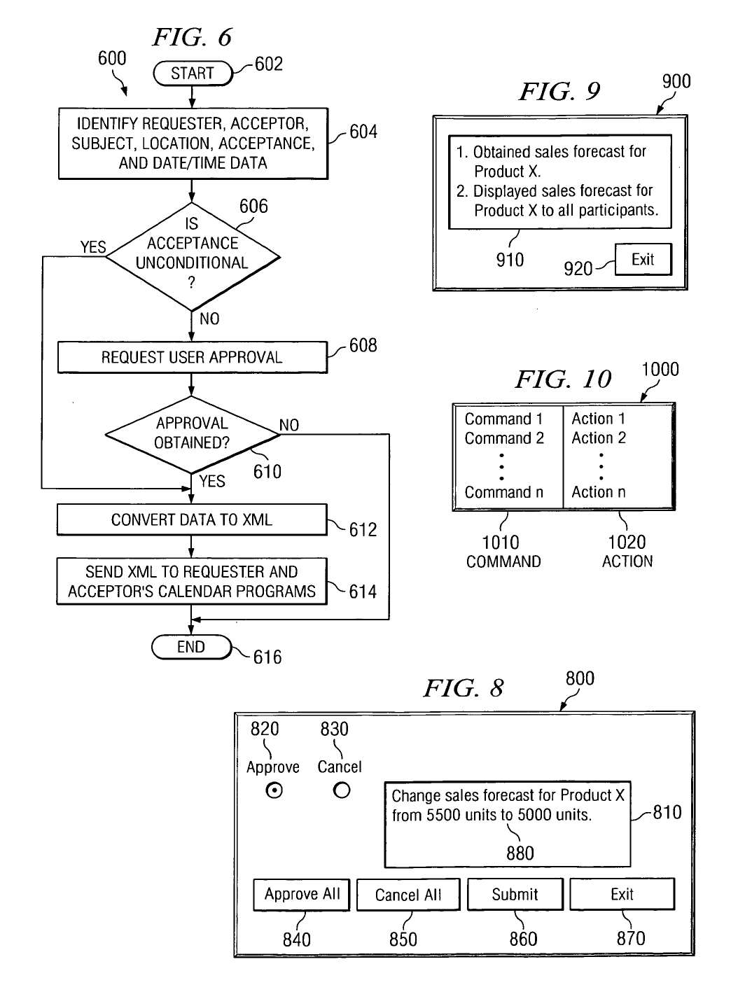

FIG. 6 shows the logic of step 418 (“perform action associated with command”) executed by command finding program 400 for the example command identified in segment B of chat transcript 500 depicted in FIG. 5. To schedule an appointment, command finding program 400 begins (602) by identifying requester 506, accepter 508, appointment subject 512, location 516, the nature of the acceptance 514, and date and time 518. Command finding program 400 then assesses if the acceptance is unconditional (606). In this case, the phrase “my schedule is open,” indicates unconditional acceptance, so command finding program 400 converts the data obtained in step 604 to XML (612) and sends the XML to the requester's 506 and accepter's 508 calendar programs 224 (614) prior to terminating (616). XML is a structured format for data exchange between computer programs.

In the event of a conditional acceptance, such as, “I might be able to meet,” command finding program 400 requests user approval (608) before proceeding. If approval is obtained in step 610, then steps 612 and 614 occur. Otherwise, command finding program 610 terminates (616).

FIG. 7 depicts chat window 700. Chat window 700 has utility section 710 from which the user can select actions such as file, edit, view, action, or help. Chat identifier area 730 shows with whom the chat is being conducted. Chat transcript 500 appears within chat transcript area 720 and displays the conversation between the user and other chat participants. Chat window 700 provides controls that enable the user to interact with segment finding program 300 and command finding program 400. Radio buttons 794 control whether or not command finding program 400 provides real-time reports of the results of actions taken in chat transcript area 720. Radio buttons 796 control whether or not command finding program 400 can take action upon finding a command without obtaining user approval. Radio buttons 798 control whether or not real-time reports of the results of actions taken by command finding program 400 are displayed to all participants or only to the user within the chat transcript area 720.

Text box 780 provides the user with a space for composing text prior to sending it to the chat participants using button 790 or prior to sending it only to the segment finding program 300 using button 792. The radio button 798 and button 792 make it possible for the user to receive information from the command finding program 400 without making the command or the result visible to the other participants. Alternatively, the user can elect to display the command but hide the result from the other participants, hide the command but display the result to the other participants, or display both the command and the result to the other participants. Each user independently controls how segment finding program 300 and command finding program 400 interact with text entered into their text box 780 and what actions are taken by command finding program 400 on their behalf.

As segment finding program 300 identifies segments, they may be color-coded and/or highlighted. Similarly, command finding program 400 may also identify commands 770 to the user, such as by underlining them. Icons 760 are used to further identify commands and provide the user with a button for linking to multiple potential actions associated with a command and/or providing approval or disapproval of actions associated with a command.

In the example illustrated in FIG. 7, radio buttons 794, 796, and 798 are turned on. Therefore, when command finding program 400 identifies first command 770 regarding the current sales forecast for Product X and the user approves execution of the associated action, a result 772 of “5500 units” is displayed to all chat participants. In the example, a second command 774 regarding changing the sales forecast has also been identified by command finding program 400 but has not yet been approved by the user. The user uses button 782 to view all commands that are not yet approved and uses button 784 to view all commands executed during the chat session.

Icon 760, radio buttons 794, 796, 798, and buttons 782, 784, 790, and 792, along with the highlighting and/or underlining of segments 740 and 750 and commands 770 and 774, can be implemented using VB, C++, Java or AWT/Swing. The features can be implemented as a plug-in to reduce the cost of a new IM program and/or making users download and install a new IM program.

FIG. 8 depicts pending commands window 800 that enables the user to view pending command list 810. The user selects radio button 820 to approve or radio button 830 to cancel each of pending commands 880. Button 840 approves all pending commands 880 by selecting radio button 820 for each of pending commands 880. Button 850 cancels all pending commands 880 by selecting radio button 830 for each of pending commands 880. Button 860 submits the choices made using radio buttons 820 and/or 830. Button 870 exits pending commands window 800 and returns the user to chat window 700 without approving or canceling any of pending commands 880. In an alternative embodiment, pending commands window 800 could include provisions for searching, sorting, and filtering the pending command list 810.

FIG. 9 depicts command log window 900 that enables the user to view command log 910. Button 920 exits command log window 900 and returns the user to chat window 700. In an alternative embodiment, command log window 900 could include provisions for searching, sorting, and filtering the command log 910. In an alternate embodiment, the user could click on an item in the command log, and view the actual programming commands.

FIG. 10 depicts command list 1000. Command list 1000 consists of one or more commands 1010, each of which has one or more associated actions 1020. Commands 1010 provide the logic necessary for command finding program 400 to find commands within segments. In an alternative embodiment, separate logic within command finding program 400 could translate the many ways of stating a particular command into a standard form listed as a command 1010.

The system and method for automatic instant message transcript segmentation disclosed above enables a user to integrate chat marking with different applications such as email, calendar programs, content management, search engines, and workflow engines so that automatically marked segments can be introduced into these other applications, and automatically perform the desired tasks without any user intervention and transparent to the user. Examples of applications which could be automatically linked to the segments are analysis applications, data mining applications, report generation applications, indexing for search applications, content posting (such as FAQ, Q&A, project information, topic information, news, education/training, etc.) to web sites, content posting to team room, content posting to email, content posting to newsgroups and so forth resulting in easier and more accurate relevance searches.

With respect to the above description, it is to be realized that the optimum dimensional relationships for the parts of the invention, to include variations in size, materials, shape, form, function, manner of operation, assembly, and use are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

What is claimed is:

1. A method for automatically segmenting content from an instant messaging transcript and applying commands contained within the content segments comprising:
(a) scanning for a segment in the instant messaging transcript;
(b) responsive to finding a segment, scanning for a command contained within the segment; and
(c) responsive to finding a command, performing an action associated with the command.

2. The method of claim 1, further comprising reporting to a user that the action has been performed.

3. The method of claim 1, wherein steps (a) through (c) may take place retrospectively after completion of an instant messaging transcript.

4. The method of claim 1, wherein step (c) is preceded by prompting a user to approve performance of the action.

5. The method of claim 1, further comprising reporting to a user the results of the action.

6. The method of claim 1, wherein step (b) is preceded by responsive to finding a segment, identifying the segment to a user.

7. The method of claim 1, wherein step (c) is preceded by responsive to finding a command, identifying the command to a user.

8. The method of claim 1, wherein steps (a) through (c) are performed automatically by a computer.

9. The method of claim 1, wherein the action comprises sending at least a portion of the segment to a pre-designated addressee.

10. The method of claim 1, wherein the action comprises sending at least a portion of the segment to a computer program.

11. The method of claim 1, wherein the action comprises sending an XML message containing at least a portion of the segment to a computer program.

12. The method of claim 1 wherein the command further comprises a word contained within the chat segment that can be recognized by a computer program through comparison to a command list so that upon recognition of the command a computer will be instructed to perform the action associated with the command.

13. The method of claim 1 wherein the action further comprises the result of instructions given to a computer in response to recognition and application of the command by a program.

14. A program product operable on a computer comprising:
a computer-usable medium;
wherein the computer usable medium comprises instructions for a computer to perform steps comprising:
(a) receiving an instant messaging transcript from an instant messaging session;
(b) scanning the instant messaging transcript for a segment;
(c) responsive to finding a segment, scanning for a command contained within the segment; and
(d) responsive to finding a command, performing an action associated with the command.

15. The program product of claim 14, wherein a user can specify that at least a portion of the instant messaging transcript be sent only to the computer and not to any other participants in the instant messaging session.

16. The program product of claim 14, wherein a user can specify that a result from the action be displayed only to the user and not to any other participants in the instant messaging session.

17. The program product of claim 14, wherein a user can specify that a result from the action be displayed to all participants in the instant messaging session.

18. The program product of claim 14, wherein prior to performing step (d), the computer must receive approval from a user.

19. The program product of claim 14, wherein the action comprises prompting a user to approve performance of an additional action.

20. The program product of claim 14 wherein the command further comprises a word contained within the chat segment that can be recognized by a computer program so that upon recognition a computer will be instructed to perform the action associated with the command.

21. The program product of claim 14 wherein the action further comprises the result of instructions given to a computer in response to recognition and application of the command by a program.

22. The program product of claim 14 further comprising instructions to identify topic shifts in the instant messaging conversation.

23. The program product of claim 14 further comprising instructions to report to a user that an action has been performed by logging the action in a command log.

24. The program product of claim 14 further comprising instructions to obtain permission from a user before executing an action.

25. The program product of claim 14 further comprising instructions to report the result of an action to the user.

26. The program product of claim 14 further comprising instructions to identify a found command to a user.

27. The program product of claim 14 further comprising instructions to identify a found segment to the user.

28. The program product of claim 14 wherein an instruction is given to the computer after completion of an instant messaging transcript.

29. The program product of claim 14 further comprising instructions, responsive to locating a command in a segment, to send a portion of the segment to a pre-designated addressee.

30. The program product of claim 14 further comprising instructions to send a portion of the segment to a computer program.

31. The program product of claim 14 further comprising instructions to send an XML message containing at least a portion of the segment to a computer program.

32. The program product of claim 14 further comprising instructions to prompt a user to approve performance of an additional action.

33. A system for automatically segmenting content from an instant messaging transcript and applying commands contained within the content segments comprising:
a first computer having a first memory and a first processor;
a second computer having a second memory and a second processor connected to the first computer;
a third computer having a third memory and a third processor connected to the first computer and the second computer;
an instant messaging program loaded into the first memory, second memory, and third memory;
a segment finding program loaded into the third memory;
a command finding program loaded into the third memory; and
a command list loaded into the third memory.

34. The system of claim 33, wherein the segment finding program receives input from the instant messaging program loaded into the third memory, scans for a segment, and executes the command finding program responsive to finding a segment.

35. The system of claim 33, wherein the command finding program receives a segment from the segment finding program, scans for a command contained within the segment, and performs an action from the command list responsive to finding a command contained within the command list.

36. The system of claim 33, further comprising a command log loaded into the third memory.

37. The system of claim 34, further comprising a pending command list loaded into the third memory.

38. The system of claim 34, further comprising an application selected from the group consisting of word processors, email programs, spreadsheet programs, and calendar programs loaded into the third memory.

39. The system of claim 33 wherein the command further comprises a word contained within the chat segment that can be recognized by a computer program so that upon recognition of the command a computer will be instructed to perform the action associated with the command.

40. The system of claim 33 wherein the action further comprises the result of instructions given to a computer in response to recognition and application of the command by a command finding program.
